(19) United States
(12) Patent Application Publication
(10) Pub. No.: US 2026/0310568 A1
(43) Pub. Date: Oct. 8, 2026

(54) METHOD OF DATA CORRUPTION ON AN UART COMMUNICATION BUS

(71) Applicant: Microchip Technology Inc., Chandler, AZ (US)

(72) Inventor: Avinash Halageri, Bangalore (IN)

(73) Assignee: Microchip Technology Inc., Chandler, AZ (US)

(21) Appl. No.: 19/208,634

(22) Filed: May 15, 2025

(30) Foreign Application Priority Data
Apr. 2, 2025 (IN) 202511032770

(51) Int. Cl. G06F 11/26; G06F 11/22

(52) U.S. Cl. CPC G06F 11/261; G06F 11/2221

(57) ABSTRACT

A method comprises transmitting a data transmission from a first universal asynchronous receiver/transmitter (UART) to a communication bus, altering the data transmission on the communication bus, and receiving a data reception by a second UART from the communication bus. A system has a communication bus, a first universal asynchronous receiver/transmitter (UART) connected to the communication bus to transmit a data transmission to the communication bus, a second UART connected to the communication bus to receive a data reception from the communication bus, a logic circuit to alter the data transmission on the communication bus.

### RELATED PATENT APPLICATION

This application claims priority to commonly owned Indian Patent Application No. 202511032770 filed April 2, 2025, the entire contents of which are hereby incorporated by reference for all purposes.

### TECHNICAL FIELD

The present disclosure relates to Universal Asynchronous Receiver Transmitter (UART) communications, in particular, controlled data corruption in Universal Asynchronous Receiver Transmitter (UART) communications.

### BACKGROUND

Universal Asynchronous Receiver-Transmitter (UART) communication is widely used in embedded systems and microcontrollers for serial data transmission. UART provides a simple and reliable method for exchanging data between devices, utilizing a standardized protocol that includes start bits, data bits, optional parity bits, and stop bits. This communication method is employed in various applications, ranging from automotive systems to industrial control equipment.

In the field of functional safety, particularly in automotive applications, rigorous testing and validation procedures are implemented to ensure the reliability and robustness of communication systems. These procedures often involve simulating various fault conditions to verify the system's ability to detect and respond to errors. However, creating controlled fault scenarios in UART communication can be challenging due to the asynchronous nature of the protocol and the limited access to the physical transmission layer.

Existing methods for injecting faults into UART communication may not adequately simulate real-world error conditions or may alter the data before it reaches the communication bus. Additionally, these methods may lack precision in timing and placement of the induced errors, potentially limiting the effectiveness of functional safety testing procedures.

Branch coverage at software unit level needs to be at 100% for ASIL B and above as per ISO26262-Part6. For communication between UART transmitter and receiver; roughly translates to two branches, wherein “same data” being received as that was transmitted, to indicate a PASS, and wherein data mismatch to indicate a FAILURE. Both the scenarios may be tested/covered in order to obtain 100% branch coverage.

One method is to initiate a DMA transfer to the UxTXB register while the data transmission is in progress, or use a timer while the data transfer is in progress, alter the contents of UxTXB. This alters the data at the “source”. The modified data gets transmitted instead of the original data -> no data corruption.

Another method is to use a timer and while the data transfer is in progress, virtually connect the RTS line to TX line and disconnect after 1 bit time to resume normal communication. Inactive state of RTS line sends a logic HIGH, doesn’t work if the data that needs to be corrupted is also logic HIGH.

There is a need for a method to corrupt data during a communication over the UART communication bus.

### SUMMARY

Aspects provide a method for data corruption on a Universal Asynchronous Receiver Transmitter (UART) communication bus, comprising: initializing a timer to lapse after a predetermined number of bits have been transmitted; filling data in a UART First-In-First-Out (FIFO) buffer; starting the timer and initiating UART data transmission; and upon the timer lapsing, manipulating a Transmit Polarity (TXPOL) bit in a UART Configuration (UxCON) register to invert transmit polarity on the UART communication bus, thereby corrupting data during transmission.

According to aspects, there is provided a method comprising: transmitting a data transmission from a first universal asynchronous receiver/transmitter (UART) to a communication bus; altering the data transmission on the communication bus; and receiving a data reception by a second UART from the communication bus.

An aspect as in the preceding paragraph provides a method, wherein the data transmission comprises less than or equal to eight bytes of data.

An aspect as in one of the preceding two paragraphs provides a method, wherein altering the data transmission comprises altering a state of the communication bus.

An aspect as in one of the preceding three paragraphs provides a method, wherein altering the data transmission comprises inverting a polarity of the communication bus.

An aspect as in one of the preceding four paragraphs provides a method, wherein altering the data transmission comprises altering for a period of time.

An aspect as in one of the preceding five paragraphs provides a method, wherein altering the data transmission comprises altering at least one bit of data of the data transmission.

An aspect as in one of the preceding six paragraphs provides a method, wherein altering the data transmission comprises setting an invert value in a UART register to invert the interpretation of logic levels on the UART communication bus from a normal operation state, and setting an idle value in the UART register to revert the interpretation of logic levels on the UART communication bus to the normal state.

An aspect as in one of the preceding seven paragraphs provides a method, comprising waiting after transmitting data transmission from the first universal asynchronous receiver/transmitter (UART) to the communication bus to begin altering the data transmission on the communication bus.

An aspect as in one of the preceding eight paragraphs provides a method, comprising waiting after altering the data transmission on the communication bus to begin receiving the data reception by the second UART from the communication bus.

An aspect as in one of the preceding nine paragraphs provides a method, comprising comparing the data transmission to the data reception, wherein a communication failure is confirmed when the data transmission is different than the data reception.

According to aspects, there is provided a system comprising: a communication bus; a first universal asynchronous receiver/transmitter (UART) connected to the communication bus to transmit a data transmission to the communication bus; a second UART connected to the communication bus to receive a data reception from the communication bus; a processor; a non-transitory computer-readable medium storing instructions that, when executed by the processor, cause the processor to alter the data transmission on the communication bus.

An aspect as in the preceding paragraph provides a system, comprising a timer to count when the data transmission is being transmitted to the communication bus.

An aspect as in one of the preceding two paragraph provides a system, comprising a register, and wherein the non-transitory computer-readable medium storing instructions that, when executed by the processor, cause the processor to alter the data transmission on the communication bus by setting a set value in the register and resetting a reset value in the register.

An aspect as in one of the preceding three paragraphs provides a system, wherein the data transmission comprises less than or equal to eight bytes of data.

An aspect as in one of the preceding four paragraph provides a system, wherein the non-transitory computer-readable medium storing instructions that, when executed by the processor, cause the processor to alter the data transmission on the communication bus by inverting a polarity of the communication bus.

An aspect as in one of the preceding five paragraphs provides a system, wherein the non-transitory computer-readable medium storing instructions that, when executed by the processor, cause the processor to alter the data transmission on the communication bus for a period of time.

An aspect as in one of the preceding six paragraphs provides a system, wherein the non-transitory computer-readable medium storing instructions that, when executed by the processor, cause the processor to compare the data transmission to the data reception, wherein a communication failure is confirmed when the data transmission is different than the data reception.

According to aspects, there is provided a microchip comprising: a universal asynchronous receiver/transmitter (UART) to transmit a data transmission; a UART FIFO buffer to store the data transmission; a UART register to invert polarity of a UART communication bus when set with an invert value, and to idle polarity of the UART communication bus when set with an idle value; a logic circuit to set the invert value in the UART register and set the idle value in the UART register.

Aspects as in the preceding paragraph provide a microchip, comprising a timer to count when the data transmission is being transmitted.

An aspect as in one of the preceding two paragraphs provides a microcontroller, wherein the logic circuit is to set the invert value in the UART register for a period of time and set the idle value in the UART register after lapse of the period of time.

### BRIEF DESCRIPTION OF THE DRAWINGS

A more complete understanding of the disclosure and the advantages thereof may be acquired by referring to the following description, taken in conjunction with the accompanying drawings and wherein:

FIG. 1 is a block diagram of a UART system illustrating UART data communications and operations to corrupt data during communication over the UART communication bus and corrupt the data “on the bus”, rather than at the source.

FIG. 2 shows a flow chart of a method to corrupt data during communication over a UART communication bus by a control logic and corrupt the data “on the bus”, rather than at the source.

FIG. 3 shows a UART communication timing diagram illustrating a data corruption mechanism.

FIG. 4 shows a flow chart of a method of a fault injection software routine that is used to inject faults during data communication between transmitter and receiver over an UART communication bus.

The drawings accompanying and forming part of this specification are included to depict certain aspects of the disclosure. The reference number for any illustrated element that appears in multiple different figures has the same meaning across the multiple figures, and the mention or discussion herein of any illustrated element in the context of any particular figure also applies to each other figure, if any, in which that same illustrated element is shown. The features illustrated in the drawings are not necessarily drawn to scale. It should be noted that the features illustrated in the drawings are not necessarily drawn to scale.

### DESCRIPTION

According to aspects, there is provided a method wherein the mechanism is a fault injection software routine that is used to inject faults during data communication between transmitter and receiver over an UART communication bus. Fault injection done using existing hardware features available in the UART module. Part of Functional Safety Diagnostics developed for the UART module used in Electronic Control Units (ECUs) in automotive applications.

Aspects provide a method of data corruption on an UART communication bus. It provides a controlled corruption of data on the “UART communication bus”. The TXPOL is altered, which alters the notion of logic HIGH and logic LOW on the communication bus, to corrupt the data. The data may be altered “on the fly” “on the UART communication bus”. This may be a part of Functional Safety Diagnostics used in the automotive domain, but implementation dependent on features of the UART, hence can be used in other segments as well.

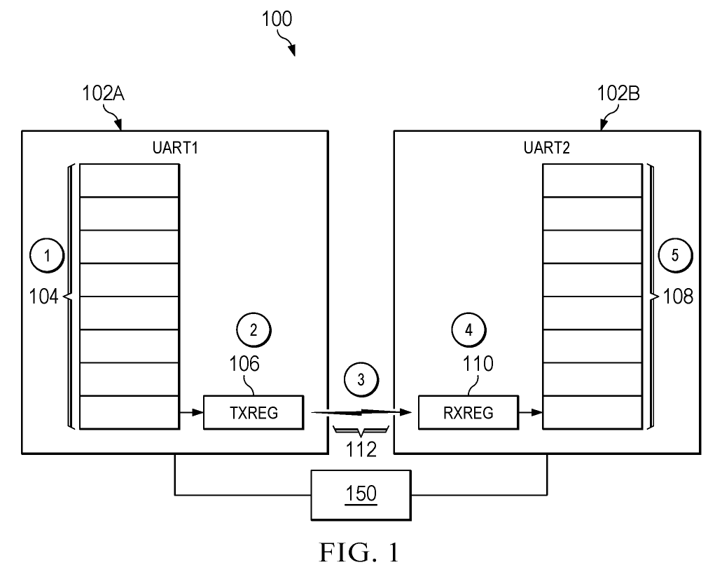

FIG. 1 is a block diagram of a UART system. The UART system 100 has two UART modules 102A and 102B and a communication line or communication bus 112 that connects the two UART modules 102A and 102B. UART modules 102A and 102B may include any suitable components for facilitating data transmission and reception, such as buffers, registers, and communication lines. A control logic 150 is to inject faults during data communication between the UART modules 102A and 102B over the communication line or communication bus 112.

UART module 102A may include a transmit FIFO (First-In-First-Out) buffer 104, which may be used to store data awaiting transmission. The transmit FIFO buffer 104 may be capable of holding any suitable amount of data, such as 8 bytes. UART module 102A module may include a transmit register (TXREG) 106. In some implementations, data may be transferred in chunks from the transmit FIFO buffer 104 to the transmit register (TXREG) 106. The transmit register (TXREG) 106 may be responsible for converting parallel data into serial format for transmission over the communication line or communication bus 112. This conversion process may involve shifting out bits of data at a specified baud rate.

UART module 102B has receive FIFO buffer 108 and a receive register 110. The UART system 100 has a communication line or communication bus 112 that connects the transmit register (TXREG) 106 to the receive register (RXREG) 110. On the receiving end, the incoming serial data may first arrive at the receive register (RXREG) 110 of the receiving UART module 102B. The receive register (RXREG) 110 may be responsible for converting the incoming serial data back into parallel format. Finally, the received data may be transferred to the receive FIFO buffer 108 of the receiving UART module 102B. This receive FIFO buffer 108 may store the received data until the receiving device is ready to process it.

As shown in FIG. 1, the UART communication process may involve the transfer of data between UART modules 102A and 102B. According to Operation 1, data may be stored in the transmit FIFO (First-In-First-Out) buffer 104 to await transmission. According to Operation 2, data may be transferred in chunks from the transmit FIFO buffer 104 to the transmit register (TXREG) 106 and the transmit register (TXREG) 106 converts parallel data into serial format for transmission over the communication line or communication bus 112. According to Operation 3, the serialized data may be sent over the communication line or communication bus 112, which connects the transmitting UART module 102A to the receiving UART module 102B. During Operation 3, the control logic 150 injects faults into the data being transmitted on the communication bus 112. According to Operation 4, the receive register (RXREG) 110 converts the incoming serial data back into parallel format and transmits the data in chunks to the receive FIFO buffer 108. According to Operation 5, the receive FIFO buffer 108 may store the received data until the receiving device is ready to process it.

A data corruption mechanism may be implemented. First, normal data transmission may begin with the START bit, followed by the data bits of the first few bytes. Second, at a precisely timed moment, corresponding to the transmission of a specific bit (for example, the 5th bit of the 4th byte), the TXPOL bit may be set to “1”. Third, setting the TXPOL bit to “1” may cause an immediate inversion of the UART communication bus polarity. This may result in the current bit being transmitted with an inverted logic level. Fourth, after a brief delay, which may be as short as the duration of a single bit being transmitted, the TXPOL bit may be reset to “0”. Fifth, resetting the TXPOL bit to “0” may revert the UART communication bus 112 polarity to its original state, allowing the subsequent bits to be transmitted normally. Sixth, the transmission may continue with the remaining data bits and the STOP bit, completing the UART frame.

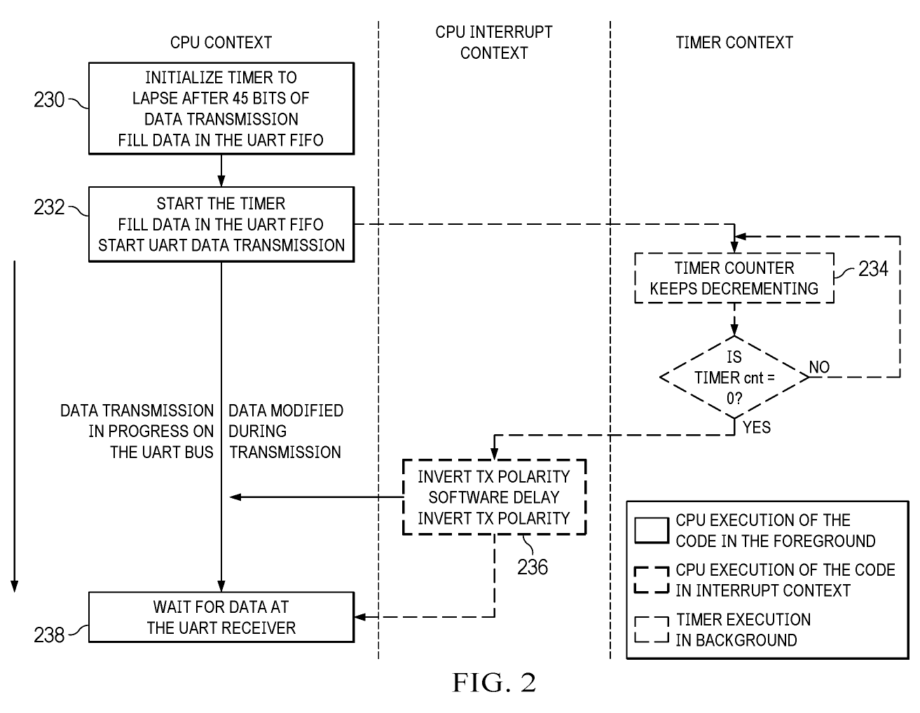

FIG. 2 shows a flow chart of a method to corrupt data during communication over the UART communication bus 112 by the control logic 150 and corrupt the data “on the bus” 112 (see FIG. 1), rather than at the source. The data stream to be sent is 8 bytes of data. The control logic 150 performs operation 230, which is to initialize a timer to lapse after a predetermined number of bits have been transmitted. In some examples, the timer may be set to lapse after forty-five bits of data transmission. This timing may correspond to four complete bytes plus five additional bits. Specifically, a timer is set to lapse after forty-five bits of data wherein (one START bit + eight bits of data + one STOP bit) = one data byte in UART; four such bytes + one START bit + four bits of the fourth byte.

The control logic 150 then performs operation 232, which is to start the timer, fill the data in transmit FIFO buffer 104, and start UART data transmission across the communication bus 112. As the timer counts down, data transmission may proceed normally on the UART communication bus 112.

At operation 234, the control logic 150 decrements the timer counting while the data is transmitted in parallel over the communication bus 112 until the timer count reaches “0”.

Once the timer lapses, the control logic 150 performs operation 236, which is to enter an interrupt context. In this context, the method may manipulate the TXPOL (Transmit Polarity) bit in the UxCON (UART Configuration) register. Specifically, the TXPOL bit may be set to “1” and then reset to “0”. This manipulation may cause a brief inversion of the transmit polarity on the UART communication bus 112. The control logic 150 sets a TXPOL bit in the UxCON register to “1” and then reset the TXPOL bit to “0”. This alters the data being transmitted on the communication bus 112. Specifically, it alters the fifth bit of the fourth byte being transferred. Because data is altered “on the bus” 112, the received data is different from the transmitted data. The timing of operation 236 may be precisely controlled to affect a specific bit within the data stream. In some examples, the method may be configured to corrupt the fifth bit of the fourth byte being transferred. By altering the TXPOL bit at this precise moment, the method may effectively corrupt the data on the UART communication bus itself, rather than at the source of transmission.

The control logic 150 then performs operation 238, which is to receive the altered data at the UART module 102B and compare the transmitted data with the received data to confirm the data was altered while being transmitted on the communication bus 112. At operation 238, the method may wait for data at the receiver UART module 102B. Due to the controlled corruption introduced in operation 236, the received data may differ from the transmitted data, allowing for testing of error detection and handling mechanisms.

The method may provide a controlled means of introducing data corruption on a UART communication bus, which may be particularly useful for functional safety diagnostics in automotive applications or other systems requiring robust error handling capabilities.

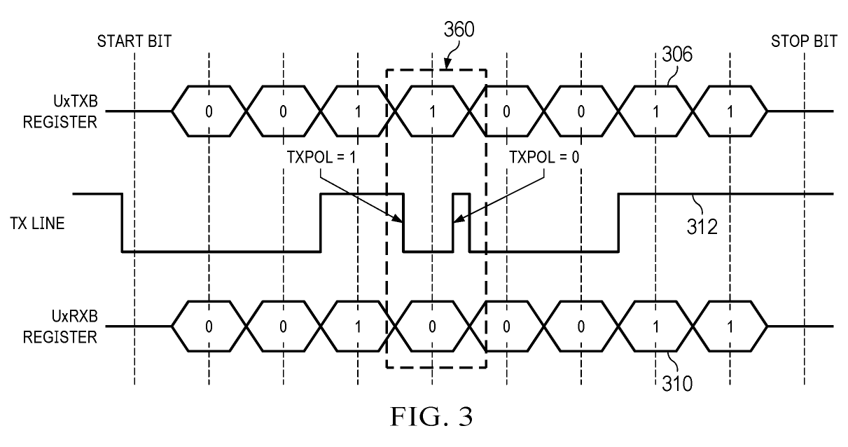

FIG. 3 shows a UART communication timing diagram illustrating a data corruption mechanism. FIG. 3 illustrates the sequence of events during data transmission and the implementation of a data corruption mechanism using TXPOL (Transmit Polarity) bit manipulation. The diagram may depict two parallel signal paths: the UART Request signal and the bus signal. The data transmission may be represented by a series of hexagonal blocks, each containing a hexadecimal value corresponding to a data byte. The sequence of data bytes shown in FIG. 3 may be 8, 8, 1, 5, 8, 6, 1, 1. These bytes may represent any suitable data being transmitted over the UART communication bus (TX LINE). A section of the communication where data corruption occurs may be highlighted by the dotted-line box 360 in the diagram. Within this section, two curved arrows may indicate a polarity inversion taking place on the communication bus (TX LINE). This inversion may be triggered by manipulating the TXPOL bit, which may temporarily invert the logic levels on the communication bus (TX LINE) during transmission.

In particular, FIG. 3 shows a clock cycle diagram of the method illustrated by FIG. 2 to corrupt data during communication over the UART communication bus and corrupt the data “on the bus”, rather than at the source. Clock cycles 306 for the transmit register (TXREG) 106, the clock cycles 312 for the communication bus 112, and clock cycles 310 for the receive register (RXREG) 110 are shown (see also FIG. 1). The TXPOL bit in the control logic 150 works on inverse logic to alter the state of communication bus 112. The control logic 150 sends a LOW for logic “1” and HIGH for Logic “0”. When TXPOL = 1, the control logic 150 inverts the polarity of the communication bus 112, which sends logic LOW on the communication bus 112. When TXPOL = 0, the control logic 150 reverts the state of the communication bus 112, which sends Logic HIGH on communication bus 112. The width of the control timing can be adjusted to corrupt as many bits as desired. In this example case, one bit is corrupted, but any number of bits may be corrupted, without limitation.

Controlled manipulation of the TXPOL bit may allow for the corruption of a single bit or a small number of bits within the data stream, without affecting the overall structure of the UART frame. The START and STOP bits may remain intact, ensuring that the receiver can still properly synchronize with the transmitted data. The timing diagram in FIG. 3 may clearly illustrate how the normal data transmission is interrupted at a precise moment when the TXPOL bit is toggled, causing a controlled corruption of the data bit being transmitted at that instant. After the corruption event, normal transmission may resume, allowing for the testing of error detection and handling mechanisms in UART-based communication systems.

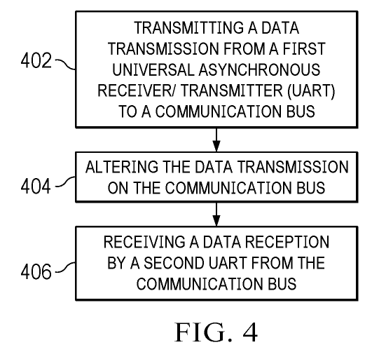

FIG. 4 shows a flow chart of a method of a fault injection software routine that is used to inject faults during data communication between transmitter and receiver over an UART communication bus. A data transmission is transmitted 402 from a first universal asynchronous receiver/transmitter (UART) to a communication bus. The data transmission is altered 404 on the communication bus. A data reception is received 406 by a second UART from the communication bus.

One aspect of functional safety diagnostics involves testing the integrity of data communication between different components of an automotive ECU. The UART protocol is commonly used for serial communication in automotive applications due to its simplicity and reliability. However, to thoroughly test the robustness of UART-based communication systems, scenarios where data corruption occurs may be simulated.

The method described herein provides a controlled means of introducing data corruption on a UART communication bus. By deliberately corrupting data during transmission, the method allows for testing of error detection and handling mechanisms in automotive ECUs. This controlled corruption may help in verifying that the system can appropriately respond to and manage communication errors, thereby enhancing the overall safety and reliability of the automotive electronic systems.

The method for data corruption on a UART communication bus may be implemented using existing hardware features of the UART module, allowing for precise control over the corruption process. The method may utilize any suitable timer to determine when to corrupt data on the UART communication bus.

Timer configuration may play a crucial role in the implementation of the data corruption method. The timer may be set to lapse after a predetermined number of bits have been transmitted. This timing may be adjusted based on the specific requirements of the application. For example, the timer may be configured to lapse after 45 bits of data transmission, which may correspond to 4 complete bytes plus 5 additional bits.

The software implementation of the method may involve careful coordination between the timer interrupt and the UART transmission process. When the timer lapses, the method may enter an interrupt context where the TXPOL (Transmit Polarity) bit in the UART Configuration register may be manipulated. This manipulation may cause a brief inversion of the transmit polarity on the UART communication bus, effectively corrupting the data being transmitted at that precise moment.

The method may be flexible in terms of the number of bits that can be corrupted. While the described implementation may focus on corrupting a single bit, the method may be adjusted to corrupt multiple bits if needed. This adjustment may be achieved by extending the duration for which the TXPOL bit is inverted or by manipulating the TXPOL bit multiple times during a single transmission.

The software implementation may also include error detection and handling mechanisms to verify the effectiveness of the data corruption process. These mechanisms may compare the transmitted data with the received data to confirm that the intended corruption has occurred and to test the system's response to corrupted data.

By utilizing the UART hardware features and carefully timing the manipulation of the TXPOL bit, the method may provide a controlled and repeatable means of introducing data corruption on the UART communication bus. This approach may be particularly useful for functional safety diagnostics in automotive applications or other systems requiring robust error handling capabilities.

The method of data corruption on a UART communication bus may have various applications in functional safety diagnostics, particularly in automotive Electronic Control Units (ECUs). This method may provide a controlled and repeatable means of introducing data corruption, which may be crucial for testing the robustness and error-handling capabilities of automotive communication systems.

In automotive applications, ensuring the reliability and safety of electronic systems may be paramount. The UART protocol may be commonly used for serial communication in automotive ECUs due to its simplicity and reliability. However, scenarios where data corruption occurs may be simulated to thoroughly test the integrity of UART-based communication systems.

The method described herein may offer several advantages over previous approaches to data corruption in UART communication. Unlike methods that alter data at the source or rely on hardware flow control signals, this method may corrupt data directly on the UART communication bus. This approach may more accurately simulate real-world scenarios where data corruption occurs during transmission rather than at the point of origin.

By utilizing existing hardware features of the UART module, such as the TXPOL (Transmit Polarity) bit, the method may achieve precise control over the corruption process. This may allow for targeted corruption of specific bits within the data stream, providing a more granular approach to testing error detection and handling mechanisms.

The method may be flexible and adaptable to various testing requirements. The timing and extent of data corruption may be adjusted by modifying the timer settings and the duration of TXPOL bit manipulation. This flexibility may enable testing of different error scenarios and edge cases, which may be valuable for comprehensive functional safety diagnostics.

In automotive ECUs, where safety-conscious functions may rely on accurate data communication, this method may help validate the system's ability to detect and respond to communication errors. By introducing controlled data corruption, developers may verify that error detection mechanisms are functioning correctly and that the system can appropriately handle corrupted data.

The method may be implemented using standard development tools and hardware. It may be tested using MPLAB X IDE, Curiosity Development board, and dsPIC33AK512MPS512 DIM. This compatibility with widely used development platforms may facilitate integration into existing testing and validation processes for automotive ECUs.

Furthermore, this method may contribute to meeting the stringent requirements of automotive safety standards, such as ISO 26262. By enabling thorough testing of error handling in UART communication, the method may support the development of more robust and reliable automotive electronic systems.

Although examples have been described above, other variations and examples may be made from this disclosure without departing from the spirit and scope of these disclosed examples.

What is claimed is:

1. A method comprising:
transmitting a data transmission from a first universal asynchronous receiver/transmitter (UART) to a communication bus;
altering the data transmission on the communication bus; and
receiving a data reception by a second UART from the communication bus.

2. The method of claim 1, wherein the data transmission comprises less than or equal to eight bytes of data.

3. The method of claim 1, wherein altering the data transmission comprises altering a state of the communication bus.

4. The method of claim 1, wherein altering the data transmission comprises inverting a polarity of the communication bus.

5. The method of claim 1, wherein altering the data transmission comprises altering for a period of time.

6. The method of claim 5, wherein altering the data transmission comprises altering at least one bit of data of the data transmission.

7. The method of claim 1, wherein altering the data transmission comprises setting an invert value in a UART register to invert an interpretation of logic levels on the UART communication bus from a normal operation state, and setting an idle value in the UART register to revert the interpretation of logic levels on the UART communication bus to the normal state.

8. The method of claim 1, comprising waiting after transmitting data transmission from the first universal asynchronous receiver/transmitter (UART) to the communication bus to begin altering the data transmission on the communication bus.

9. The method of claim 1, comprising waiting after altering the data transmission on the communication bus to begin receiving the data reception by the second UART from the communication bus.

10. The method of claim 1, comprising comparing the data transmission to the data reception, wherein a communication failure is confirmed when the data transmission is different than the data reception.

11. A system comprising:
a communication bus;
a first universal asynchronous receiver/transmitter (UART) connected to the communication bus to transmit a data transmission to the communication bus;
a second UART connected to the communication bus to receive a data reception from the communication bus;
a processor; and
a non-transitory computer-readable medium storing instructions that, when executed by the processor, cause the processor to alter the data transmission on the communication bus.

12. The system of claim 11, comprising a timer to count when the data transmission is being transmitted to the communication bus.

13. The system of claim 11, comprising a register, and wherein the non-transitory computer-readable medium storing instructions that, when executed by the processor, cause the processor to alter the data transmission on the communication bus by setting a set value in the register and resetting a reset value in the register.

14. The system of claim 11, wherein the data transmission comprises less than or equal to eight bytes of data.

15. The system of claim 11, wherein the non-transitory computer-readable medium storing instructions that, when executed by the processor, cause the processor to alter the data transmission on the communication bus by inverting a polarity of the communication bus.

16. The system of claim 11, wherein the non-transitory computer-readable medium storing instructions that, when executed by the processor, cause the processor to alter the data transmission on the communication bus for a period of time.

17. The system of claim 11, wherein the non-transitory computer-readable medium storing instructions that, when executed by the processor, cause the processor to compare the data transmission to the data reception, wherein a communication failure is confirmed when the data transmission is different than the data reception.

18. A microchip comprising:
a universal asynchronous receiver/transmitter (UART) to transmit a data transmission;
a UART FIFO buffer to store the data transmission;
a UART register to invert polarity of a UART communication bus when set with an invert value, and to idle polarity of the UART communication bus when set with an idle value; and
a logic circuit to set the invert value in the UART register and set the idle value in the UART register.

19. The microchip of claim 18, comprising a timer to count when the data transmission is being transmitted.

20. The microchip of claim 18, wherein the logic circuit is to set the invert value in the UART register for a period of time and set the idle value in the UART register after lapse of the period of time.
